(19) United States
(12) Patent Application Publication
(10) Pub. No.: US 2024/0418620 A1
(43) Pub. Date: Dec. 19, 2024

(54) METHOD AND ARRANGEMENT FOR OPTICAL DETECTION OF DIELECTRIC PARTICLES

(71) Applicant: HOLTRA AB, Göteborg (SE)

(72) Inventors: Fredrik EKLUND, Göteborg (SE); Fredrik HÖÖK, Göteborg (SE); Erik OLSÉN, Mölndal (SE); Daniel MIDTVEDT, Romelanda (SE)

(21) Appl. No.: 18/706,283

(22) PCT Filed: Oct. 31, 2022
(86) PCT No.: PCT/SE2022/050995

§ 371 Date: Apr. 30, 2024

(30) Foreign Application Priority Data
Nov. 1, 2021 (SE) 2130293-0
May 30, 2022 (SE) 2230165-9

(51) Int. Cl. G01N 15/0227; G01N 15/00; G01N 15/01; G01N 15/06; G01N 15/075; G01N 15/1434

(52) U.S. Cl. CPC G01N 15/0227; G01N 15/01; G01N 15/075; G01N 15/1434; G01N 2015/0038; G01N 2015/0233; G01N 2015/0681; G01N 2015/0687; G01N 2015/1454

(57) ABSTRACT

The invention relates to a method for optically characterizing dielectric particles such as virus or biological particles of submicrometre size, by e.g. holographic microscopy. In particular, the invention is directed to mixing dielectric particles with non-dielectric particles which when mixed will bind to the dielectric particle.

### TECHNICAL FIELD

The invention relates to a method for detecting dielectric particles such as virus or biological particles of submicrometric size by optical detection, e.g. holographic microscopy. In particular, the invention is directed to mixing dielectric particles with non-dielectric particles which when mixed will bind to the dielectric particle.

### BACKGROUND ART

There are a large number of methods to detect virus, most of which can be categorized into Nucleic acid (RNA/DNA) detection, detection of antigens or corresponding antibodies produced and detection of their impact on live cells.

Cell culture is an old method and something of a gold standard. Different virus types can cause different morphological changes of the cells which can be detected by microscopy. Changes can be highlighted by staining with fluorescent dyes. If no visible changes occur for the virus type to be analysed, the “death rate” of the cells can be monitored. An advantage of cell culture is that it detects only viable virus particles, not “dead” ones or fragments. A disadvantage is that it takes 1-10 days to perform.

Polymerase chain reaction (PCR) is a method to detect DNA or RNA through amplification. The method is very sensitive (low detection limit) and specific (can differentiate between virus variants). It is commonly used for diagnosis. Amplification does however take time (1h) and the higher the amplification the greater the risk of false positive detections. As the method detects DNA/RNA molecules it can give positive results for some time after an infection is over—it does not require intact and viable virus particles to give a positive result.

There is a wide range of methods which are based on reactions with virus antigens, antibodies against the virus or other molecules. These methods include simple, cheap and fast tests with comparably high sensitivity. This group include commonly used methods such as ELISA (Enzyme linked immunosorbent assay) and Western blot (electrophoresis of precipitate) with visual results.

An emerging group of methods is biosensors, where reagents are attached to a surface and their interaction with target molecules are detected optically, electrochemically, etc. These are generally targeted against biomolecules (DNA, antibodies, proteins, etc). Biosensors are potentially faster and cheaper than common methods such as PCR and ELISA. Surface based methods however often suffers from much background signal due to non-specific binding to the surface.

Whereas molecular based methods all have the disadvantage of not selectively detecting only viable virus particles, there is also available a wide variety of virus counting methods. One established method to count virus particles is electron microscopy, which however requires very expensive equipment and extensive training to use. The variability of the results is also comparably high. Hence, there is a need for an improved method for detecting and analysing dielectric particles such as virus.

### GENERAL DESCRIPTION OF THE INVENTION

The invention relates to a method for detecting dielectric particles, e.g. virus or biological particles, of submicrometric size.

When referring to dielectric particles herein, it shall be assumed those particles are of submicrometer size unless otherwise stated. In a similar way, when referring to non-dielectric particles, they shall be assumed to be non-dielectric nanoparticles unless otherwise stated. When referring to nanoparticle-labelled dielectric particles, it is meant complexes composed of dielectric particles of submicrometer size and non-dielectric nanoparticles. Nanoparticle-labelled dielectric particles discussed herein are prepared by mixing submicrometer sized dielectric particles with non-dielectric nanoparticles whereby non-dielectric nanoparticles and dielectric particles of submicrometer size bind to each other to form complexes comprising non-dielectric nanoparticles and dielectric particles of submicrometer size. A nanoparticle-labelled dielectric particle as defined above may also be referred to as a mixed aggregate particle.

The method includes [step a], comprising the feature of preparing a sample by mixing dielectric particles of submicrometer size with non-dielectric nanoparticles. During the mixing, non-dielectric particles and dielectric particles of submicrometer size bind to each other to form nanoparticle-labelled dielectric particles to be detected. Depending on the properties of the dielectric particles as well as the non-dielectric particles, the number of non-dielectric particles which binds to the dielectric particle may differ. Hence, after the mixing, at least a portion of the non-dielectric nanoparticles are bound to the dielectric particles of sub-micrometre size to form nanoparticle-labelled dielectric particles. These nanoparticle-labelled dielectric particles are to be detected as disclosed below in [step b].

Step a: The mixing of the dielectric particle and non-dielectric particles is made in order to improve the detectability of the dielectric particle, e.g. virus or other biological matter. The non-dielectric particles to be used are nanoparticles. The non-dielectric particles may be prepared by tethering antibodies or other molecules having site specific binding to the dielectric particle, e.g. virus, to be detected in order to attach to the dielectric particle. By using suitable non-dielectric particles, the dielectric particle of interest may be easier to detect and distinguish from other particles and impurities in a sample. The non-dielectric particles may bind to the dielectric particle due to inherent properties and affinity between the dielectric particle and the non-dielectric particles without the need to specifically prepare the non-dielectric particles. However, the non-dielectric particles may also be prepared by tethering antibodies or other molecules having site specific binding to a virus to be detected in order to attach to the virus or biological particle or being some kind of general tethering arrangement to improve tethering and affinity for binding to a specific particle or group of particles having a common structure or composition. The selectively binding label particles are for example nanoparticles for which the optical absorption cross section is larger than the optical scattering cross section, as for example metallic nanoparticles, since that improves the methods ability to separate between naturally occurring particle aggregates and the particle binding of interest.

In [step b], the particles in the sample are optically detected. In this step, at least one parameter in each of the following parameter groups i. and ii. are determined
i. the real part of the optical field or optical extinction
ii. imaginary part of optical field or phase shift, alternatively or in addition diffusivity-derived hydrodynamic diameter

Hence, there are at least two parameters which are to be detected from a sample which is to be optically detected according to this method. When submicron particles are illuminated by light, the particles will affect the passing light in two ways in the direction of light propagation; the light intensity will decrease (extinction) and light will shift phase compared to light not passing the particle. A quantitative measure of a particle's light extinction is its extinction cross section. Extinction is caused by two additive phenomena, absorption and scattering. Quantitative measures of these phenomena are absorption cross section and scattering cross section, respectively. For a dielectric particle, the scattering cross section is larger than the absorption cross section. Dielectric particles may absorb light to some extent due to excitation of molecules or atoms in the material, but their scattering cross section will generally be larger than their absorption cross section.

A dielectric material is a material which does not conduct electricity at all or function very poorly as a conductor. Typically, materials with a resistivity larger than 10⁸ Ωm are considered dielectric as these are good insulators, but also materials with at least 1 Ωm resistivity, such as biological materials, may be considered dielectric in the present context. Non-dielectric materials thus can conduct electricity and include conducting materials such as metals and some forms of carbon, as well as semiconducting materials such as CdS, Si, Ge, etc. Metals typically have a resistivity of 10⁻⁷-10⁻⁸ Ωm, whereas semiconducting materials are typically in the range 10⁻⁵-10⁶ Ωm. The direct current resistivity of the corresponding bulk material is however not an accurate predictor for dielectric/non-dielectric properties of or the optical response of very small particles in response to the electric field component of light.

The response of a material or of a colloidal particle to the electrical field component of incident light can be described by its complex Refractive Index (RI) (not to be confused with complex optical fields discussed later in this text). The real part of the refractive index is often referred to as just “refractive index” and is the ratio of the speed of light in vacuum to the speed of light in the material. The real part of the refractive index thus affects the phase shift of light passing the particle compared to light not passing the particle. The imaginary part of the refractive index describes instead the absorption of light passing the particle. Particles made of non-dielectric materials can absorb light due to various resonance phenomena and thus have an imaginary RI which is non-zero. For metals the imaginary RI is typically larger than the Real RI, whereas for semiconducting materials the Imaginary RI is at least 1/100 of the Real RI, typically more than 1/20 of the Real RI and often more than 1/10 of the Real RI. The complex RI may vary with particle size and shape, but not drastically. The absorption and scattering of light do however scale strongly with particle size. In the Rayleigh region, i.e. particles< 1/10 of the light wavelength, the scattering of a particle scales with particle volume squared. Meanwhile, the light absorption of a nanoparticle scales only with the particle volume. For nanoparticles which have a substantial Imaginary RI, there may therefore be size ranges where the absorption contributes more to light extinction than scattering.

The terms dielectric particle and non-dielectric particle used herein can also be seen as relative terms instead of absolute values. In the case when it is referred to a dielectric particle to be detected, the dielectric particle shall be more dielectric than the non-dielectric particles.

Dielectric particles may for example consist of or comprise inorganic minerals as well as organic molecules and biological material.

Small non-dielectric particles, which may also be referred to as conducting particles, may exhibit plasmon resonance under excitation by light, which will cause them to strongly absorb incident light. This is due to resonance of the cloud of free electrons on the surface. Such particles are commonly referred to as plasmonic nanoparticles. Plasmonic nanoparticles have a high absorption cross section which contributes to a high extinction cross section. For very small plasmonic nanoparticles the scattering cross section contribute only to a very small degree to the extinction cross section, whereas for large plasmonic nanoparticles the scattering cross section may make out a significant part of the extinction cross section.

The optical properties of plasmonic nanoparticles depend on the type of material, size and shape. Size differences in nanoparticles made of the same material may be distinguished by their different resonance properties. For example, dispersions of spherical gold nanoparticles of different size have visibly different colour due to resonance at different wavelengths. The size effect on colour is used in many diagnostic applications since it causes a colour change when plasmonic nanoparticles aggregate. Gold nanoparticles can be synthesized in many precise shapes, tailoring them to have their absorption peak at any desirable visible wavelength and also at infrared wavelengths. The shape effect is weaker for very small gold nanoparticles (5-10 nm) but is very significant at e.g. 50-100 nm.

A single gold nanoparticle can absorb light millions of times stronger than a single fluorescent dye molecule. Although gold nanoparticles are convenient and commonly used, other metals such as silver (resonance at blue wavelengths) platinum or palladium can also be used. Plasmonic metal particles need not be homogeneous, but can also be for example a metal film coated on a dielectric particle, and many composites have been described. Some types of carbon particles also have plasmonic resonances and have been demonstrated for virus detection.

Nano size semiconducting particles may also have a high absorption cross section, one class of such particles are commonly referred to as quantum dots. Quantum dots are typically in the diameter range 2-6 nm and typically comprise one or several semiconducting materials, e.g. CdS. Core-shell particles are sometimes used as quantum dots, with different materials in the core and the shell. Quantum dots exhibit fluorescence due to size dependent quantum effects and this gives them a high absorption cross section relative to their scattering cross section.

As mentioned above, the optical effect of a particle on incident light passing a particle is two-fold; phase shift and extinction. For dielectric particles the phase shift (integrated over the projection area of the particle) is proportional to Particle Volume multiplied with the refractive index difference between particle and surrounding medium. If the refractive index of the particle is known, the phase shift can thus be used to estimate the size of dielectric particles.

If the optical field of light passing a sample with particles is measured and determined, the optical field of the background illumination is normalized to 1 and subtracted, the optical field of the particle is isolated. If the optical field of a particle is expressed as a complex number, the Imaginary part for a small dielectric particle is approximately equal to the phase shift of the passing light:

$$ϕ ( {E}_{p} ) = arctan ( \frac{Im ( {E}_{p} )}{1 + Re ( {E}_{p} )} ) \approx arctan ( Im ( {E}_{p} ) ) \approx Im ( {E}_{p} ) ,$$

where ϕ is the phase shift, Eₚ is the optical field of the particle, Im(Eₚ) is the imaginary part of the field of the particle and Re(Eₚ) is the real part of the field of the particle. This will be further explained in the detailed description, including some figures explaining the relationships, but the general reasoning is as follows: In a complex number plane depicted with a Real axis and Imaginary axis, the light which has passed a particle achieves a phase shift and a smaller absolute signal due to extinction than the light which has not interacted with any particle. If the background light is subtracted, the field of the particle is extracted, which has a negative Real part and a positive Imaginary part.

The approximation that Imaginary part of the particles optical field is equal to its integrated phase shift is valid for dielectric particles since their field have a high Imaginary part relative to its Real part. It is however not generally valid for non-dielectric particles as these often have a relatively higher Real part due to their higher absorption and/or scattering.

If this is expressed as vectors in a complex orthogonal coordinate system, optical extinction causes a shortening of the vector corresponding to light having passed the particle and will translate into a negative Real part of the particle's optical field. The higher the extinction the higher the negative Real part. When the optical field of the particle is much smaller than the field of the illumination, the Real part is approximately the extinction cross section divided by 2.

Optical fields for different particle types may thus be distinguished. In general, dielectric particles have a high Imaginary part (Im) and a comparatively low Real part (Re). The ratio of Im/Re is high. Non-dielectric particles have a low imaginary part and high negative real part. The ratio of Im/Re is low. If dielectric and non-dielectric particles aggregate, they will have both a high Real and a high Imaginary part and an intermediate ratio of Im/Re.

Hence, by using complex mathematics when describing the optical field, the real part of the optical field may be used as a measure which in many ways correlates to the optical extinction. As disclosed above, the real part, and extinction, is in general more of interest for non-dielectric particles than for the dielectric particles. Concerning the imaginary part, it correlates to the phase shift and is in general more significant for the dielectric particle which is to be analysed than for the non-dielectric particles added to bind to the dielectric particle. This must not always be the case but is for example valid when a relatively large dielectric particle, e.g. a virus, is mixed with small non-dielectric particles, e.g. nanoparticles made from gold. Due to differences in their shape, size and material properties, the different particles will have a very different impact on the optical field and affecting extinction dependent parameters quite differently as well as affecting phase shift in different ways. Generally speaking, when having a dielectric particle to be analysed which is mixed with non-dielectric smaller particles, e.g. nanoparticles made of a metal such as gold, and the non-dielectric particles are designed to bind to the dielectric particles, there will be a distinguishing pattern from the three different kinds of particles which are to be found in the mixture; free dielectric particles, free non-dielectric particles and dielectric particles with bound non-dielectric particles. The free dielectric particles and dielectric particles with bound nanodielectric particles will cause a major impact on the phase shift which also corresponds to the imaginary part of the optical field as expressed as a complex number. In general, the detected values of phase shift or the imaginary part of the particles field will not be much affected by the bound non-dielectric particles and the detected value will be of the same magnitude for both free dielectric particles and dielectric particles with bound non-dielectric particles. In particular this will be valid when the mass or volume of the total number of non-dielectric particles bound to the dielectric particles is small in relation to the volume or mass of the dielectric particle. As previously described, the influence of separate non-dielectric particles, or even clusters of non-dielectric particles, on the phase shift, or imaginary value of the optical field as expressed as a complex number, will be low or very low. Hence, a strong detection signal of the phase shift indicates that there is dielectric particle detected, e.g. a virus, either free or with bound non-dielectric particles.

Concerning extinction, or the real part of the optical field expressed as a complex number, it will be almost the other way around and the detection of dielectric particles will be rather low. In particular, the real part of the complex number being used to define the optical field is low for the dielectric particles compared to the imaginary part, in particular if this comparison is made in comparison with the ratio of the real part and imaginary part for the non-dielectric particles. Hence, there is a rather significant detection of extinction for free non-dielectric particles as well as for dielectric particles having one or several non-dielectric particles bound thereto. In particular, the detection of the real part from a particle may be somewhat proportional or affected by the number of non-dielectric particles bound thereto and the detected value of the real part or extinction may thus be used to verify if the signal corresponds to what should be the expected number of non-dielectric particles bound to the dielectric particle. Hence, from the real part, or the measured extinction of a particle, this parameter is expected to be low or very low for a dielectric particle with no non-dielectric particles bound. The imaginary part or the phase shift is expected to be rather high from single non-dielectric particles or clusters thereof. However, the signal corresponding to the absolute value of the optical field of the particle is in general expected to be higher from a dielectric particle having several non-dielectric particles bound to it than from a single non-dielectric particle and even being somewhat proportional to the number of non-dielectric particles adhered to the dielectric particle. In order to analyse the particles, dielectric particles labelled with non-dielectric particles and populations of particles are identified and differentiated from other detected particles and populations of particles, such as free or clusters of non-dielectric particles and unlabelled dielectric particles, by identifying particles as dielectric particles labelled with non-dielectric particles when they have a higher ratio of parameter from group i. to parameter from group ii. than expected for dielectric particles and having a lower such ratio than expected for individual non-dielectric particles or clusters thereof. A suitable class of non-dielectric particles to be used is nanoparticles, e.g. plasmonic nanoparticles.

Hence, by using at least one parameter from each one of parameter groups i. and ii., characterization of particles may be enabled. It may for example be possible to categorize detected particles into particle populations with different population density maxima in the parameter space of the said at least two parameters. There is a wide variety of different clustering techniques known which may be used in order to categorize particles into different particle populations. Clustering can be defined as the task of identifying groups, populations or clusters in a data set. One way of identifying clusters of data is to use density based clustering which is disclosed in the article “Density-based clustering” (Kriegel et al., WIREs Data Mining and Knowledge Discovery 2011, volume 1, pages 231-240 DOI: 10.1002/widm.30). In density-based clustering, a cluster is a set of data objects spread in the data space over a contiguous region of high density of objects. Density-based clusters are separated from each other by contiguous regions of low density of objects. Data objects located in low-density regions are typically considered noise or outliers.

In the present invention, density-based clustering may be applied for the detected particles using at least one parameter from each one of parameter groups i. and ii. in step b to categorize detected particles into particle populations with different population density maxima in the parameter space of the said at least two parameters. Still further methods and algorithms for identifying clusters or populations in a data set are for example connectivity-based clustering (hierarchical clustering), centroid-based clustering, distribution-based clustering, density-based clustering or grid-based clustering. Hence, a multitude of different methods for grouping a set of objects, e.g. data of a detected particle, and defining a cluster or population of data may thus be used.

This will be better shown in the detailed description where it is disclosed how different populations may be identified. In general, there will be populations of free dielectric particles rather close to and aligned essentially along the imaginary axis having a rather low value with small spread in its real part value. Free non-dielectric particles, or possibly also clusters of non-dielectric particles, will be aligned close to and along the real axis having small spread in the imaginary part of the optical field. Hence, dielectric particles having a considerable detected value of both the imaginary and real part in the complex optical field will thus be considered as being bound to non-dielectric particles. In particular if the non-dielectric particles are provided with some specific binder for attaching to a specific particle, e.g. a specific virus, they may be used to detect a particular particle of interest.

If a small strongly absorbing non-dielectric particle bind to a larger dielectric particle, the non-dielectric particle will predominantly affect the Real part of the combined particles' field. This is apparent if both particles are weakly interacting with light and thus the optical field of the particle is much smaller than the field of the illumination light, and the induced phase shift angles are thus very small.

The size of small particles can be determined by their Brownian motion, e.g. by tracking the particles in a microscope image and determine their median displacement. This diffusivity-derived size can be referred to as hydrodynamic diameter, Dₕ. For predominantly dielectric particles, Dₕ is to a large extent correlated with the imaginary part and with the phase shift.

Based on the above discussion, suitable optical parameters to detect dielectric particles with bound non-dielectric nanoparticles are the Real part and the Imaginary part of the optical field of the particles/aggregates, since the Real part correlate to a large extent with the extinction cross section and thus with the volume of bound non-dielectric nanoparticles, and the Imaginary part correlate to the largest extent with the volume of the dielectric particle. However, there are many alternative parameters which may be used as the imaginary part can be replaced with the induced phase shift of the particle or even with its hydrodynamic size to categorize and differentiate different particle types. Likewise, the Real part may be replaced by the absolute value of the measured optical field of light having passed the particle as these two are highly correlated for small particles and transmitted light imaging.

However, the parameter or parameters to be detected from parameter group ii. may suitably comprise the imaginary part of the optical field or phase shift.

The imaginary part of the optical field may thus be used as a parameter in parameter group ii.

In a similar way, the real part of the optical field of the particle is used as a parameter in parameter group i. It is of course suitable to use both the imaginary part and real part together as in the case calculations are performed to find either of these parameters from using a complex mathematic model of the optical field, it is in general an available and obvious option to also retrieve the other one of the imaginary or real part if already one of these parameters have been isolated and retrieved.

When for example, the present invention is used to selectively detect a specific kind of dielectric particle such as a certain type of virus, there is a risk of false detections in the form of virus debris to which the non-dielectric particles may bind. In such cases it is advantageous to use a third independent parameter to confirm that e.g. an intact virus particle of expected size has been detected. By tracking the particles and determine their diffusion and thus their hydrodynamic size, such an independent confirmation parameter is achieved. Hence, according to one aspect of the invention, the dielectric particles labelled with non-dielectric nanoparticles are thus identified within a 3-dimensional parameter space made out of the real part and the imaginary part of the optical field of the particle and the hydrodynamic size of the particle. It may of course also be possible to use phase shift achieved by some other method to replace the imaginary part of the optical field or detect extinction by some other way instead of using the real part of the optical field. However, the method may include that the imaginary part of the optical field is used as a parameter in group ii, the real part of the optical field is used as a parameter in parameter group i, and the diffusion-based hydrodynamic size is used as an independent parameter relative to the other two to categorize the particles.

It may also be possible to estimate the mass of dielectric particles with non-dielectric particles, less the non-dielectric particles, where the mass of the dielectric particle is derived from the Imaginary part of the optical field of the dielectric particles labelled with non-dielectric particles. This feature has the benefit that the imaginary part may be used also for this purpose if the imaginary part already is known. Still another advantage is that the mass of the dielectric particle can be determined relatively independently of the bound non-dielectric particles. This is because the bound non-dielectric particles make out a small part of the volume of the aggregate and a have a very small effect on the imaginary part of the optical field relative to the dielectric particle. Furthermore, as discussed above, the imaginary part is proportional to VΔn and if Δn and the density of the particle is known, its mass can be determined. For the special case of biological particles, Δn is proportional to the mass concentration of biological molecules within the particles and VΔn is therefore proportional to the dry mass of the particle. The mass of individual virus particles and other small biological particles can thus be determined.

The refractive index of dielectric particles labelled with non-dielectric particles, less the label nanoparticles may also be defined by the present method. The refractive index of the dielectric particle may be derived from the Imaginary part of the optical field of the dielectric particles labelled with non-dielectric particles in combination with the estimated hydrodynamic radius of the dielectric particle e.g. derived from diffusivity. The refractive index of the dielectric particles can be determined relatively independently of the bound non-dielectric particles. One conventional method is to use the optical phase shift combined with the hydrodynamic size of the particle to determine the refractive index. If instead using the imaginary part in place of the phase shift, the effect of the bound non-dielectric particles is reduced. The bound non-dielectric particles will affect also the hydrodynamic diameter, it may therefore be advantageous to use not the hydrodynamic diameter of the dielectric/non-dielectric particle aggregates, but the hydrodynamic diameter of the dielectric particles prior to binding, or to make an estimation of how much the non-dielectric particles contribute to the hydrodynamic diameter.

As is apparent from the above description, the invention can be used to detect a specific dielectric particle type, e.g. a specific type of virus, in a heterogeneous dispersion by binding non-dielectric particles to specific receptors. A further possibility is to use two or more different types of non-dielectric particles having absorption maximum at different wavelengths and functionalized to be capable of binding to different binding receptors and illuminate the sample with light of two different wavelengths to detect the two or more different types of binding. Hence, by selecting different binders and/or different types of non-dielectric particles, it may be possible to improve characterization of similar groups of dielectric particles to be detected.

There are several different microscopy methods which may be used for detecting nanoparticles and determining the above described categories of parameters, i.e. parameters from group I and II. Holography may be defined as methods where the optical field is reconstructed without making any assumptions about the particles to be characterized. Methods which can be used to carry out the present invention includes both holographic and other methods. In the following, off-axis Digital Holographic Microscopy (DHM) will serve as main example as a suitable method and be described in detail further below. However, as long as the microscope is designed to enable to define parameters from group I and II, there are a many other types of methods which may be used to extract the parameters necessary in addition to the off-axis digital holographic microscopy method. For example, in DHM it is not necessary to have an angle (off-axis) between the two beams directed at the image sensor, if instead several images are captured under different optical conditions to reconstruct one optical field. For example, the reference beam path length can be varied between captured images, this method is known as phase shifting holography. This requires however additional computational capacity and a higher capture rate of raw images. Furthermore, DHM may be realized without beam splitters designed to separating light into two separate beam paths and instead make use of gratings, grids or lattices to function as beam splitters in order to affect the light to split into different portions while continuing to share a common light beam path. Hence, the use of the term “means for dividing the base light beam into different portions” is meant to cover a wide range of beam spitters including cube beam splitters, plate beam splitters, fiber splitters, lattices, gratings and grids which can induce a shift in the direction of light and causing different portions of light to interfere with each other at the detector.

Another alternative method is Gabor holography, often referred to as Inline holography, which uses no reference beam. Instead, particles are imaged slightly out of focus, to visualize their diffraction rings which are analysed by fitting to theoretical optical models (e.g. Mie theory). Thus, it may be argued it is not really a holographic method, since the optical field is not reconstructed without assumptions about the particle properties. Nevertheless, the method can determine both phase and amplitude and is thus in principle possible to use for the present invention. In practice it is however less practically useful for particles smaller than the wavelength of light. Application of a semi-transparent spatial filter (also referred to as twilight filter) has been demonstrated in order to decrease the detection limit of Gabor/inline holography (Goto, K. and Y. Hayasaki, Opt Lett, 2015). It is however not obvious how to numerically compensate for a spatial filter in order to achieve absolute optical field information.

Still another alternative is Ptychography and Fourier Ptychography which is a group of methods capable of retrieving both phase and intensity information from brightfield microscopy images, they could thus potentially be used for carrying out the invention. They have the advantage of being able to image a large field of view with simple optics and low magnification. However, they are dependent on capturing a large number of images under different illumination conditions to generate one final processed image. Imaging rapidly diffusing colloids is thus challenging, since a very high camera frame rate would need to be used, and postprocessing is computationally heavy.

Below will be described in detail a suitable microscope set-up and microscopic method to determine the optical parameters from group I and II using Digital Holographic Microscopy (DHM). Hence, the method for detecting dielectric particles of submicrometer size as disclosed above where the particles are detected and characterized by holographic microscopy may include the use of a digital holographic microscope, DHM, comprising
A coherent light source for creating a base light beam for illuminating a sample in a first image plane,
A sample holder for holding a sample to be illuminated,
A detector, e.g. a camera, arranged to record images of light transmitted through a sample in the sample holder,
A first beam splitter for dividing the base light beam from the coherent light source into at least a first divided beam and a second divided beam, and
A light beam guiding system for guiding said base light beam or said first divided light beam through the sample and further arranged to guide said first and second divided beam to reunite at a reuniting point before the first and second beams are directed to the detector

The base light beam may be split downstream or upstream of the sample. In case the base light beam is split upstream of the sample, the base light beam is preferably split by a beam splitter such that one divided beam bypasses the sample and is a beam with unscattered background light while the other beam comprises scattered and unscattered light from being directed through a sample. These beams, the first and second divided beam, may also be referred to as reference beam, which is the second divided beam which not passes through the sample to get scattered light from particles in the sample, and an object beam, which is the first divided beam passing through the sample and having scattered light from particles while passing through the sample. By beam splitter is meant to include any kind of device which can divide a beam in two or more beams. The beam splitter may be a traditional one comprising two prisms, commonly called a cube beam splitter, a plate beam splitter or fibre optic splitting devices.

The DHM comprises a coherent light source for creating a base light beam for illuminating a sample. The coherent light source may for example be a laser. The DHM further comprises a sample holder for holding a sample to be illuminated when being located in a first image plane by the coherent light source. The DHM also includes a detector arranged to record images of light transmitted through a sample in the sample holder. The DHM further comprises a first beam splitter for dividing the base light beam from the coherent light source into at least a first divided beam, e.g. an object beam, and a second divided light beam, e.g. a reference beam. These light beams will be guided through different paths in the DHM by a light beam guiding system. The light beam guiding system comprises suitable light guiding features such as mirrors and optical fibres for guiding said object beam to illuminate a sample contained in the sample holder and for guiding said reference beam to bypass said sample holder. There will thus be two different light beams having the same light source guided through the system. The light beam guiding system is further arranged to guide said object and reference beam to reunite at a reuniting point before the light beams are directed to the detector.

In the case of splitting the base light beam downstream of the sample, the reference beam will contain light scattered by the sample which will preferably be removed before the two beams are reunited. Removing scattered light from the reference beam may be done by focusing the beam to a focal plane where it passes a pinhole which removes scattered light while letting unscattered background light pass. This operation is similar to the spatial filter arrangement described below, but inverse.

In order to further improve the setup described above, the digital holographic microscope (DHM) could be provided with a light reducing arrangement, e.g. a spatial filter, for reducing the intensity of the background light in the object beam. The light reducing arrangement is located downstream of the sample holder and upstream of the reuniting point of the object and reference beams. According to one suitable set up, the light reducing arrangement comprises at least a first lens for collimating the light scattered by a particle comprised in the sample and focusing the background light passing through the sample at a first focal plane. A spatial filter is arranged in the vicinity of the first focal plane of said first lens in order to reduce the intensity of the focused background light such that the majority of the unscattered light passing through the sample is filtered off and the majority of the light scattered by an object, e.g. a solid particle, in the sample is guided via a light guiding system to reunite with the reference beam. The spatial filter may be a semi-transparent or opaque disk on a translucent material designed such that light scattered by the particle in the sample is allowed to pass at the sides of the disk filter. By using a spatial filter, there will be an increased ratio of light intensity from light scattered by a particle versus light passing straight through the sample and thus an increased ratio of light comprising relevant information concerning particles in the sample. To be noted, by particle is also meant to include gas bubbles and liquid droplets in addition to solid particulate matter unsolved in the sample media, e.g. water, in which the sample is contained. Hence, the DHM may be designed such that the background light unscattered by the sample in the first beam is dampened relative to the light in the same beam, scattered by the sample, by a filter.

The filter should be adapted to filter off sufficient light to improve the signal of the scattered light which in general is a lot less intense than the background light. the exact amount of how much light that is to be filtered off may vary but in general should the filter be adapted to dampen the background light unscattered by the sample by at least 50%, preferably by at least 90% or even by as much as 99% in order to reduce the background light to such an extent that the labelled dielectric particles are detectable above the background light and spatial noise, whereas the non-labelled dielectric particles are not detected above the spatial noise. Another way of expressing essentially the same desire is to state the filter should be designed to have a shape and size which is adapted to the material, size and shape of the non-dielectric particles mixed with the sample of dielectric particles such that free non-dielectric nanoparticles will remain undetected while dielectric particles with bound non-dielectric nanoparticles will be detected.

The filter should thus be designed and located in the DHM to filter off a considerable portion of the light passing straight through the sample while allowing a majority of the light scattered by particles to pass through. In case such a lens set-up as suggested above is used, the light scattered by a particle is collimated by the first lens to cover a wide area while the light passing straight through the sample will be focused at a focal point of the first lens, the spatial filter could be designed to cover a rather small area at or close to the focal point of the first lens. Such an arrangement will enable an essential portion of the light passing straight through the sample without being scattered to be filtered off while the majority of the light scattered by the particle may pass by the filter at the side of the filter. The closer to the focal point the filter is located, the smaller area will be needed to be covered by the filter to filter off light passing through the sample and thus allowing more of the light scattered by the particle to continue its path to the detector. According to one embodiment of the invention, the filter is designed to have a shape and size which is adapted to its location relative the focal point such that the filter covers at least 50 percent of the focused light from the first lens, preferably is the filter designed such that it covers essentially all (more than 90 percent) of the focused light from the first lens. The filter is preferably designed to reduce the intensity of the total light by at least 50% and even more preferably designed to filter off at least 80 or 90% of the total light. It should be noted that a complete removal of the background light is not desirable as it is essential for the method to function, the background light is needed as a reference for the scattered light. The background light, i.e. the unscattered light passing through the sample, is preferably reduced to be of the same magnitude as the scattered light is. In practice, the background light is reduced between 80-99%, i.e. by a factor 5 to 100.

The filter could be designed to have various shapes and be made from a wide diversity of material. According to one embodiment is the filter designed as a flat essentially round disc.

The filter could be made to be non-transparent or to be partially light transparent. A partially light transparent filter could be made by using a semi-transparent material covering the whole filter area or by having intermittent zones with non-transparent and transparent properties.

According to one embodiment the filter is made by depositing a metal, e.g. gold, silver, aluminium or platina, onto a transparent sheet material, e.g. glass.

Different kinds of coherent light sources may be used in the DHM. According to one embodiment the coherent light source is selected to provide light having a coherence length of at least 0.1 mm, preferably at least 0.7 mm. This may for example be achieved by using a laser having the desired coherence length. Coherent light sources in this context may have a wide range of different temporal coherence and may also provide a mixture of coherent and non-coherent light.

The light reducing arrangement could be designed to include a second lens and the filter being located between said first and second lens. The lenses need not to be identical and the first lens and the second lens may thus have different optical properties and focus length. In case a two-lens system is used, the first and second lens are preferably arranged relative each other such that their respective focal points are coinciding with each other in the space between the lenses and the filter is located in close vicinity of the coinciding focal points. Even though there is no need to use lenses having the same optical properties, it may be practically convenient to use lenses having the same optical properties and focal length as the first and second lenses.

The digital holographic microscope (DHM) could also comprise a processor. The processor may be programmed to quantify and compensate for the amplitude and/or phase change of the optical signal due to the spatial filter. Such a compensation is performed in order to quantify the optical field of particles in the sample and/or properties such as size and refractive index of particles in the sample. In order to get relevant and desired information about the particles detected, a compensation for the effects arising from including a filter in the DHM is desired to compensate for the reduced light intensity in the object beam passing through the sample compared to the light in the reference beam.

The DHM may be designed such that the object and reference beams form an off-axis configuration when the divided beams are reunited before being detected by the detector. By using an off-axis configuration it will be possible to extract information concerning different phase shifts from each single image, e.g. if the detected object is a bubble or a solid particle.

The method steps described below may be performed by the DHM described above by incorporating necessary additional features needed, e.g. a processor programmed to perform one or several of the below described steps. The method will in this case include the use of
a coherent light source for creating a light beam for illuminating a sample
a sample holder for holding a sample to be illuminated
a detector arranged to record images of light transmitted through a sample in the sample holder
a first beam splitter for dividing the light beam from the coherent light source, upstream of said sample holder into at least an object beam and a reference beam
a light beam guiding system for guiding said object beam to illuminate a sample contained in the sample holder and for guiding said reference beam to bypass said sample holder, said light beam guiding system further arranged to guide said object and reference beam to reunite at a reuniting point upstream of the detector, and
a light reducing arrangement located in the optical path of said object beam downstream of the sample holder and upstream of the reuniting point of the object and reference beams, said light reducing arrangement comprising
at least a first lens for collimating the light scattered by a particle comprised in the sample and focusing the light passing through the sample at a first focal point, and
a spatial filter arranged in the vicinity of the focal point of said first lens in order to reduce the intensity of the focused light passing through the sample. The filter is designed such that the majority of the light passing through the sample is filtered off and the majority of the light scattered by the sample is allowed to pass through at the sides of the filter.

The method comprises the steps of recording one or several images by the detector, e.g. a camera, and analysing the one or several images in order to estimate a size and/or shape and/or optical field and/or refractive index of particles in the sample. In the analysis of the one or several images, there is also a step of quantitatively compensating for the optical effect of the filter. This compensation could be made on beforehand and be included in a software which have one or several sets of compensating parameters to be used depending on which filter and/or kind of sample to be used.

The compensation may also be made by sampling a multitude of images on site by recording images with and without the filter in order to determine relevant parameters to be used for compensating for the filter. When recording the images to be used for deciding the compensation, samples comprising particles with known characteristics is preferably used, e.g. particles with a known refractive index and known size or size distribution. In general, this method is also used when determining compensation parameters for a filter included in a software.

According to one embodiment of the method, a size and/or shape of particles in the sample may be estimated by analysing the recorded images and said estimated size may be used together with a detected phase shift between the object and reference beams in order to estimate a Refractive Index (RI) of the detected particle for determination of the composition of the detected particle, e.g. distinguish a solid substance from a gas bubble. It is further possible that a size and/or shape and/or optical field and/or refractive index of particles in the sample may be estimated by quantitatively compensating for the filter to extract the absolute optical signal of the particles. The different phase shift of the light in the object beam and the reference beam, originating from the very same coherent light source, depends upon the properties of particles detected in the sample and it may be thus be possible to distinguish particles having different properties and different refractive index indices.

In order to further improve the method and characterization of the detected particles, the relative intensity of the object beam and the reference beam could be adjusted in order to optimize interference of the object and reference beam. The two beams should preferably have intensities of the same magnitude when they interfere at the camera to generate as sharp interference pattern as possible in the recorded image.

Still further improvements may be achieved if background noise is reduced by comparing recorded images and subtracting stationary features from different images. This means that the sample is recorded in a first image and background noise in each first image is reduced by subtracting one or a combination of several other recorded images, said other images are selected in order to reduce background noise in the first image effectively. The recorded microscope images will have a background speckle pattern which is due to light scattering from imperfections in the optical system, such as dust or scratches. Coherent reflections within and between optical components and the sample will also contribute to the non-uniform background. An obvious solution to this problem is to subtract a previous or later image from the presently analysed one, as this will remove these static imperfections from the image and give a uniform background against which the particles can be more easily detected. However, even very tiny vibrations will cause fluctuations in light intensity as well as lateral movement of the background pattern, making subtraction of one arbitrary image frame inadequate. One improvement which has been previously described (Midtvedt et al, Analytical Chemistry, 2020) is to iterate through a selection of 20-30 previous or later image frames and select those for subtraction which best minimize the background of the present image frame upon subtraction. An average of the selected frames is then subtracted from the present frame.

There are different ways to estimate the size of a particle. A first example of a suitable method is to analyse the Brownian motion of the particle whereby a parameter corresponding to the size of a particle, e.g. hydrodynamic diameter, may be estimated. A second example of a method, which has been described previously (Midtvedt et al, ACS Nano 2021), is to estimate the size based on the optical field information for the particle and optical theory, such as Mie theory. The first method will provide the hydrodynamic diameter of the particle, whereas the second method will provide an optical diameter which is not necessarily identical with the hydrodynamic diameter. In the first case, the refractive index (RI) can be determined from the hydrodynamic diameter or size in combination with the integrated phase shift of light passing the particle. In the second case, refractive index and size can be determined simultaneously from the optical signal/optical field information of the particle. In addition to these different selections of data to extract information from, there is also the possibility to choose between classical analysis or deep learning approaches at different stages in the analysis. Deep learning often has advantages when the signal to noise ratio is low, and also often provides shorter computation time. Hence, there is a multitude of methods in addition to the two examples of methods disclosed above which may be used for determining the size of a particle. In case a general method of deciding the size of a particle is desired, the absolute optical signal of the particles may be extracted and the size of the particle can be estimated from the absolute optical signal of the particle in relation to optical theory.

The method may be used for detecting different particle populations in the same sample. The particle populations may for example be identified through their respective relationship between two independent variables where one variable is the hydrodynamic diameter or diffusivity or any variable derived therefrom, and the other variable is an optical property such as integrated phase shift. In an alternative method, different particle populations are identified through their respective relationship between two independent optical variables such as the integrated phase shift and optical extinction cross section, or related variables.

In order to be able to extract relevant and precise data from a sample, the effect of the filter should be taken into account. The effect of the filter could be quantified by imaging a sample of particles both with and without the filter and numerically comparing the optical signal from the two measurements.

The method may include the use of a processor being programmed to quantify and compensate for the amplitude and/or phase change of the optical signal due to the spatial filter in order to quantify properties such as size, refractive index, relative phase shift, optical field, and other properties of particles in the sample. When light passes through a particle, some of the light will be scattered away and thus the intensity will decrease, and the light will also be shifted in phase relative the unscattered background light which has not passed a particle. The change in light intensity and phase relative to the background light can be predicted by Mie theory for a particle of certain size, refractive index and shape. For particles much smaller than the wavelength of light, the shape is of little importance and particles can be approximated as spheres. The size and refractive index can thus be determined from the optical field of the particle. The optical field of the particle may be expressed as a complex number, which in polar form has an amplitude (absolute value, modulus) and a phase (argument). However, when adding a spatial filter according to the present invention, the relation between light that has passed a particle and the background light is altered. The background light strongly decreases in intensity and also usually changes phase. This makes it impossible to correlate the optical field with size and refractive index of a particle with the help of Mie theory. However, it is possible to quantify the intensity and phase shift of the background light with the help of calibration particles of known size and refractive index and subsequently use this information to compensate for the spatial filter. One way to do this is to:
1) Record and analyse a video sequence of known calibration particles both with and without the spatial filter.
2) For both measurements, first normalize and subtract the optical field of the background illumination from the optical field at the individual particle, to isolate the optical field information of the particle.
3) Determine the amplitude and phase of the particle population in the two measurements, and determine a scaling factor r for amplitude by dividing the amplitude with spatial filter by amplitude without spatial filter, and determine a scaling term θ for phase by subtracting the phase with spatial filter from the phase without spatial filter.
4) Use this information in subsequent measurements to adjust the amplitude and phase of each detected particle with the predetermined scaling factors such that z₁=z₂/(re^{iθ}) where z₁ is the optical field of the particle without filter and z₂ is the optical field with filter.
5) Determine the size and refractive index of each particle based on correlation of phase and amplitude with Mie theory.

There are possible variations to the described method to mathematically compensate for the spatial filter in order to correlate the optical field information with Mie theory, for instance the compensation may be made without subtracting the background field and instead compensate the background field for the spatial filter. Another possibility is to instead of using Mie theory, apply deep learning strategies on data where a spatial filter has been applied.

By use of a spatial filter as described above, the detection limit (which is mostly correlated with the amplitude of the field of the particle) may be adapted. For example, a filter consisting of a disc of semi-transparent metal film may be selected with different film thicknesses depending on the desirable detection limit. By appropriate selection of a filter to dampen the background light and appropriate selection of non-dielectric nanoparticles for labelling, it is possible to only detect dielectric particles with adsorbed non-dielectric nanoparticles, whereas individual nanoparticles and individual dielectric particles are below the detection limit. Since DHM is a brightfield method, particles below the detection limit will blend in with the background and will not disturb the detection and analysis of the particles above the detection limit. In contrast, darkfield methods are sensitive to particles below their detection limit. For example, in scattering based nanoparticle tracking analysis (NTA), the sample is illuminated from the side relative to the line of view and the particles are imaged as bright spots on a dark background. Particles which are too small or weakly scattering to be automatically detected may still scatter enough light to give a bright and temporally fluctuating background and thus disturb the detection of the larger particles. This is particularly problematic if the concentration of small particles is much higher than the concentration of large particles. NTA can also be used in fluorescence mode, where similar problems may occur if the fluorescent dye binds also to the smaller particles. More importantly, if a high concentration of fluorescent dye has not bound to the particles of interest it may give rise to a disturbing background signal coming from dissolved dye molecules as well as dye molecules non-specifically adsorbed on non-labelled particles and on surfaces in the sample container. On the other hand, a too low concentration of dye molecules may lead to that not all particles of interest are labelled to a sufficient extent. A high dye concentration can be used and removed later, which requires an extra purification step. By using non-dielectric label particles in place of fluorescent dyes, high concentration of label nanoparticles may be used, ensuring sufficient labelling of all relevant particles, while remaining unbound non-dielectric nanoparticles do not disturb the measurement. Furthermore, by using sufficiently large nanoparticles only very few binding events are necessary for each dielectric particle.

Hence, the selection of appropriate non-dielectric particles to be used for labelling the dielectric particles to be detected may improve the detectability. The non-dielectric particles are in most cases preferably nanoparticles and in general are plasmonic nanoparticles a suitable choice, e.g. particles comprising gold, silver, palladium or platinum. As discussed above, the size is of importance and said plasmonic nanoparticles have a size e.g. a diameter or equivalent spherical diameter (or ESD) in the case of an irregularly shaped object, of less than 100 nanometres, preferably less than 50 nanometres, more preferably less than 30 nanometres and most preferably less than 20 nanometres. According to the IUPAC definition, the equivalent diameter of a non-spherical particle is equal to a diameter of a spherical particle that exhibits identical properties (e.g., aerodynamic, hydrodynamic, optical, electrical) to that of the investigated non-spherical particle. For particles in non-turbulent motion, the equivalent diameter is identical to the diameter encountered in the Stokes' law. The size of the non-dielectric nanoparticles used is thus in general smaller than the dielectric particles to be labelled. A suitable non-dielectric nanoparticle size is determined by several factors. First of all, individual nanoparticles should be below the detection limit of the instrument. For example for gold nanoparticles this limit may be between 40-100 nm. Another factor is that the nanoparticles should not substantially affect the imaginary part or phase shift of the combined aggregate. Large plasmonic nanoparticles have a higher ratio of phase shift to extinction, or imaginary part to real part than smaller particles. In the case of plasmonic gold nanoparticles, sizes below 50-60 nm are preferred for this reason. Furthermore, it is preferable if the label nanoparticles do not increase the hydrodynamic diameter too much compared to the bare dielectric particle, in order to be able to use hydrodynamic diameter as a control parameter.

As discussed above, also concentration of nanoparticles are of importance. In order to make sure enough labelling non-dielectric particles will bind to the dielectric particles of interest, the concentration of label nanoparticles could be at least 10, more preferably 50, more preferably 100 and most preferably 500 times the concentration of dielectric particles in the analysed sample.

As the labelling particles in general are a lot smaller, the total volume of labelling particles versus expected sample of dielectric particles will in many cases be of the same magnitude. Hence, the volume of attached label particles per dielectric particle will generally be less than the volume of the dielectric particle, e.g. a virus or other biological particle, more preferably less than 0.1 times and most preferably less than 0.02 times the volume of the dielectric particle.

The method disclosed above may be used in several different analyses and methods of detecting dielectric particles. The invention may be used to quantify the number concentration of nanoparticle-labelled dielectric particles in the liquid. This may be done by counting the number of detected labelled particles in the imaged volume and divide by the same volume. One way of using the method is where a sample is imaged under flow. The flow rate is determined based on the particle tracking data, the liquid volume passing the imaged volume during a period of time is determined and there is a counting of the detected dielectric particle, e.g. virus or other biological particles, during the same period of time, in order to determine the number concentration of dielectrical particles such as virus or biological particles. Hence, the method may be used for quantitative concentration determination.

The volume referred to above may be known based on the known image size and knowledge of the physical height of the sample container, e.g. microfluidic channel. When for example using DHM, the height of the sample may also be determined from the holographic information which provides information on the particle z-position relative to the optical focus. For a sample imaged under flow, a simple method is to use the median or mean particle number per image frame to divide by the volume of sample in view to achieve the number concentration. More advanced and accurate algorithms may be devised to determine the number concentration based on data from all recorded images, taking the flow rate into account. DHM is well suited for particle concentration determination since the imaged volume is uniformly illuminated and its physical size well defined.

Although brightfield methods such as DHM are well suited for carrying out the present invention, such methods have difficulty detecting small and weakly optically interacting particles against the bright background. Speckle patterns, reflections, vibrations, and ultimately photon shot noise, limits the detection of very small particles. However, if the position of the particle is known, there may still be optical information which can be extracted even if the particle is not automatically detectable, in particular if averaged over many frames to improve signal to noise ratio. There may thus be a characterization limit which is lower than the detection limit. In addition to methods discussed previously, such as background subtraction and the use of twilight spatial filters, it is also possible to improve the detection limit by using a different imaging modality to determine the particle positions and subsequently characterize them with a brightfield/twilight method such as DHM in order to carry out the invention. Such additional imaging modalities could be sideways illumination as in NTA and darkfield holography, where the particles are imaged as bright dots against a dark background enabling a lower detection limit. The method described herein could thus also be further developed to include a feature where a second illumination of the sample is provided at an angle substantially larger than zero degrees with respect to the line of view. An optical imaging arrangement could be provided such that less background light unscattered by the sample than in the twilight holography arrangement is recorded, providing a lower detection limit with respect to the optical signal of the particle. This set up with second illumination and imaging arrangement could be used to detect and determine the position of particles to be detected and subsequently using the optical signal from the same positions in the images from the twilight holography arrangement to identify and characterize labelled virus or biological particles. Another option is to use a backscattering method such as iscat, which can achieve an extremely low detection limit. Such an additional imaging modality could include illumination with a different wavelength than the one used for DHM and imaging the scattering particles with a separate camera, or on a separate part of the image sensor in the first camera. Another option could be to use a colour camera to separate the two signals.

### BRIEF DESCRIPTION OF DRAWINGS

FIG. 1 discloses mixing of sample comprising dielectric particles with nondielectric particles

FIG. 2 discloses a 3-dimensionell representation of detected properties for a sample particle

FIG. 3 discloses the detected imaginary part (Im) and real part (Re) of the optical field for dielectric particles (FIG. 3A), non-dielectric particles (FIG. 3B), a mixture of free and bound dielectric and non-dielectric particles (FIG. 3C) and the effect on the optical field when non-dielectric particles bind to dielectric particles (FIG. 3D)

FIG. 4 discloses a first embodiment of a digital holographic microscope (DHM) set up suitable to be used for detection of dielectric particles labelled with non-dielectric particles, comprising two separate beams and off-axis configuration.

FIG. 5 discloses a second embodiment of a digital holographic microscope (DHM) set up suitable to be used for detection of dielectric particles labelled with non-dielectric particles, comprising two separate beams and off-axis configuration in combination with a spatial filter.

FIG. 6 discloses a third embodiment of a digital holographic microscope (DHM) set up suitable to be used for detection of dielectric particles labelled with non-dielectric particles, comprising two beams separated downstream from the sample, and off-axis configuration in combination with a spatial filter.

FIG. 7 discloses a fourth embodiment of a digital holographic microscope (DHM) set up suitable to be used for detection of dielectric particles labelled with non-dielectric particles, comprising a grating placed in a focal plane.

FIG. 8 discloses a fourth embodiment of a digital holographic microscope (DHM) set up suitable to be used for detection of dielectric particles labelled with non-dielectric particles, comprising a lattice placed near the detector.

FIG. 9 discloses the results of example 1.

FIG. 10 discloses the results of example 2.

FIG. 11 discloses the results of example 3.

### DETAILED DESCRIPTION OF THE INVENTION

In order to improve the detectability of the virus or biological matter or other dielectric particles of interest, nanoparticles are prepared by tethering antibodies or other molecules having site specific binding to a dielectric particle, e.g. a virus or biological particle, to be detected in order to attach to the dielectric particle. By using suitable nanoparticles, the dielectrical particle may be easier to detect and distinguish from other particles and impurities in a sample.

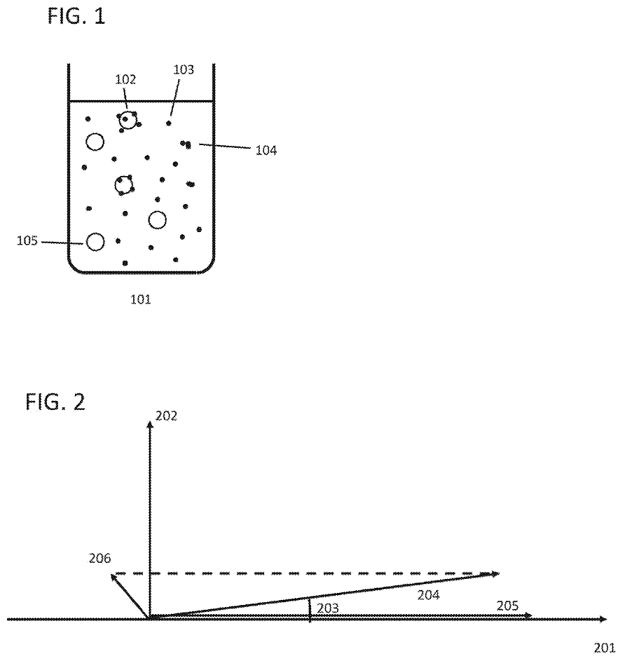

In FIG. 1 is disclosed an example of how the particles to be detected can be prepared. Non-dielectric particles 103 and dielectric particles 105 have been added to a container 101 comprising a liquid medium in order to be mixed with each other. As indicated in in FIG. 1, the size of the non-dielectric particles 103 are in general considerably smaller than the dielectric particles 105 even though this need not to be valid in all cases. Anyway, the non-dielectric particles typically have a diameter ranging from 3-30 nm in diameter and the dielectric particles typically have a diameter being about 10 times greater. During mixing, non-dielectric particles 103 will come in contact with dielectric particles 105 and attach to them and the non-dielectric particles 103 will bind to the dielectric particle 105. Depending on the properties of the dielectric particles 105 as well as the non-dielectric particles 103, the number of non-dielectric particles which binds to the dielectric particle may differ. Hence, after the mixing, at least a portion of the non-dielectric nanoparticles 103 are bound to a dielectric particle 105 so as to form mixed aggregate particles 102 of dielectric particles labelled with non-dielectric particles. In general, there is an excess of non-dielectric nanoparticles 103 and there will be single, independent non-dielectric particles 103 in the liquid medium. There may also be some of these non-dielectric particles 103 which will bind to each other so as to form clusters of non-dielectric particles 104. The mixed aggregate particles 102 of dielectric particles labelled with non-dielectric particles are thus prepared to be detected and analysed.

In order to detect the relevant parameters, a number of different microscopic methods may be used. According to one example, the idea makes use of a “twilight” feature of digital holography, typically a semi-transparent metal film placed at a focal plane to act as an optical low frequency attenuation filter (LFAF). One way which may improve the detectability could be by selecting an appropriate twilight spatial filter, the individual virus particles and individual label particles are not detected, whereas viruses with label particles adsorbed are readily visible, detectable and countable. The selectively binding label particles are preferably nanoparticles for which the optical absorption cross section is much larger than the optical scattering cross section, as for example metallic nanoparticles, since that improves the methods ability to separate between naturally occurring particle aggregates and the particle binding of interest.

A dielectric material is a material which does not conduct electricity at all or function very poorly as a conductor. Dielectric materials include inorganic minerals as well as organic molecules. Non-dielectric materials thus can conduct electricity and include conducting materials such as metals and some forms of carbon, as well as semiconducting materials such as CdS.

When submicron particles are illuminated by light, the particles will affect the passing light in two ways in the direction of light propagation; the light intensity will decrease, i.e. there will be an extinction of light, and light will shift phase compared to light not passing the particle. A quantitative measure of a particle's light extinction is its extinction cross section. Extinction is caused by two additive phenomena, absorption and scattering. Quantitative measures of these phenomena are absorption cross section and scattering cross section, respectively. For a dielectric particle, the scattering cross section is typically larger than the absorption cross section. Dielectric particles may absorb light to some extent due to excitation of molecules or atoms in the material, but their scattering cross section will generally be larger than their absorption cross section.

Small conducting particles may exhibit plasmon resonance under excitation by light, which will cause them to strongly absorb incident light. This is due to resonance of the cloud of free electrons on the surface. Such particles are commonly referred to as plasmonic nanoparticles. Such particles have a high absorption cross section which contributes to a high extinction cross section, but their scattering cross section contribute only to a small degree to their extinction cross section.

The optical properties of plasmonic nanoparticles depend on the type of material, size and shape. Dispersions of spherical gold nanoparticles of different size have visibly different colour due to resonance at different wavelengths. The size effect on colour is used in many diagnostic applications since it causes a colour change when plasmonic nanoparticles aggregate. Gold particles can be synthesized in many precise shapes, tailoring them to have their absorption peak at any desirable visible wavelength and also at infrared wavelengths. A gold nanoparticle can absorb light millions of times stronger than a single fluorescent dye molecule. Although gold nanoparticles are convenient and commonly used, other metals such as silver, having resonance at blue wavelengths, platinum or palladium can also be used. Plasmonic metal particles need not be homogeneous, but can also for example be a metal film coated on a dielectric particle, and many plasmonic composite particles have been described. Some types of carbon particles also have plasmonic resonances.

Nano size semiconducting particles may also have a high absorption cross section, one class of such particles are commonly referred to as quantum dots. Quantum dots are typically in the diameter range 2-6 nm and comprise one or several semiconducting materials, such as CdS. Core-shell particles are sometimes used as quantum dots, with different materials in the core and the shell. Quantum dots exhibit fluorescence due to size dependent quantum effects and this gives them a very high absorption cross section relative to their scattering cross section.

As mentioned above, the optical effect of a particle on incident light passing a particle is two-fold; phase shift and extinction. For dielectric particles the phase shift integrated over the projection area of the particle is proportional to Particle Volume multiplied with the Refractive index difference between particle and surrounding medium. If the refractive index of the particle and the surrounding medium is known, the phase shift can thus be used to estimate the size of dielectric particles. If the optical field of light passing a sample with particles is measured and determined, the optical field of the background illumination is normalized to 1 and subtracted, the optical field of the particle is isolated. If the optical field of a particle is expressed as a complex number, the Imaginary part for a small dielectric particle is approximately equal to the phase shift of the passing light:

$$ϕ ( {E}_{p} ) = arctan ( \frac{Im ( {E}_{p} )}{1 + Re ( {E}_{p} )} ) \approx arctan ( Im ( {E}_{p} ) ) \approx Im ( {E}_{p} ) ,$$

where ϕ is the phase shift, Eₚ is the optical field of the particle, Im(Eₚ) is the imaginary part of the field of the particle and Re(Eₚ) is the real part of the field of the particle.

In FIG. 2 is disclosed a 2-dimensional coordinate system having a Real axis 201 and an Imaginary axis 202 so as to form a complex coordinate system. Hence, a complex number can be represented in this coordinate system and, thus, an optical field expressed as a complex number can be presented in such a coordinate system Hence, a complex number can be represented in such a coordinate system and, thus, an optical field expressed as a complex number can be presented in the coordinate system. In FIG. 2 are disclosed examples of detected and calculated values of different optical field as complex numbers. The optical field of light which has not interacted with any particle, also commonly referred to as background light, is depicted as background optical field vector 205 and stretches along the Real axis 201. The optical field of light which has passed and interfered with a particle is depicted as total optical field vector 204. The light which has passed a particle achieves a phase shift causing the total optical field vector 204 to deviate from the extension direction of the background light vector 205. The phase shift is represented by a phase shift angle 203 between the background optical field vector 205 and the total optical field vector 204. Furthermore, the light passing the particle will have a shorter amplitude than the background light due to extinction. This can be seen in FIG. 2 where the real part of the background optical field vector 205, corresponding to the amplitude of the light, stretches longer along the Real axis 201 than the real part of the total optical field vector 204. If the optical field of the background light is subtracted from the optical field of light passing and interfering with the particle, the optical field of the particle is extracted. In FIG. 2, the optical field of the particle expressed as a complex number may be found by subtracting the background optical field vector 205 from the total optical field vector 204 so as to form a particle optical field vector 206, which has a negative Real part and a positive Imaginary part. The particle optical field vector 206 thus represent a complex value of the optical field of the particle.

The approximation that Imaginary part of the particles optical field, corresponding to the imaginary part of the particle optical field vector 206, is equal to its integrated phase shift is valid for dielectric particles since their field have a high Imaginary part relative to its Real part. It is however not generally valid for non-dielectric particles as these often have a relatively higher Real part due to their higher absorption and/or scattering.

Optical extinction causes a decrease in the absolute value of the optical field, also referred to as optical signal, of light having passed the particle, represented by the total optical field vector 204, compared to the illumination background light represented in the figure by background optical field vector 205, as is obvious from FIG. 2. The absolute value of the optical field corresponds to the length of a vector and the absolute value of the optical field from light having passed the particle corresponds to the length of the total optical field vector 204 and the absolute value of the optical field of the background light corresponds to the length of the background optical field vector 205. Hence, the length of the background light vector 205 is longer than the length of the total optical field vector 204. The particle optical field vector 206, which is created by subtracting the background light vector 205 from the total light vector 204 rendering this will translate into a negative Real part of the particle's optical field, i.e. a negative Real part of the particle optical field vector 206. The higher the extinction the higher the negative Real part. When the optical field of the particle is much smaller than the field of the illumination, the Real part is approximately the extinction cross section divided by 2.

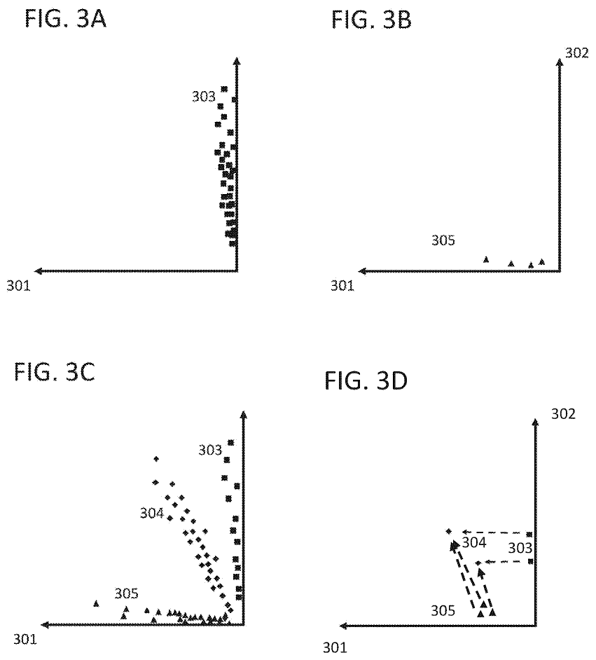

In FIGS. 3A-D are shown examples of typical values of particle optical fields for different particle types in a complex coordinate system. 301 is the real axis, 302 is the imaginary axis. In FIG. 3A is shown dielectric particles 303, herein depicted as squares, having a high imaginary part and a comparatively low negative Real part. The ratio of Im/Re is high. In FIG. 3B are disclosed non-dielectric particles 305, herein depicted as triangles, having a low imaginary part and high negative real part. The ratio of Im/Re is low. In FIG. 3C is disclosed a mixture of free dielectric particles 303, free non-dielectric particles 305 and mixed aggregates 304 of dielectric particles labelled with non-dielectric particles depicted as “diamonds”. The mixed aggregates 304 of dielectric particles labelled with non-dielectric particles will have both a high Real and a high Imaginary part and a medium ratio of Im/Re. In FIG. 3D is schematically disclosed how a detected value of the Imaginary part and the Real part is shifted as non-dielectric particles 305 bind to dielectric particles 303 to form mixed aggregates 304, i.e. dielectric particles labelled with non-dielectric particles.

With reference to FIG. 1, if a small strongly absorbing non-dielectric particle 103 bind to a larger dielectric particle 105, the non-dielectric particle will predominantly affect the Real part of the optical field of the mixed aggregate particles 102. With reference to FIG. 2, this is apparent if both particles are weakly interacting with light and thus the optical field of the particle represented by the particle optical field vector 206 is much smaller than the optical field of the illumination background light represented by the background light optical field vector 205, and the induced phase shifts angles 203 are thus very small.

The size of small particles can be determined by their Brownian motion, e.g. by tracking the particles in a microscope image and determine their median displacement. This diffusivity-derived size can be referred to as hydrodynamic diameter, Dh. For predominantly dielectric particles, Dh is to a large extent correlated with the imaginary part and with the phase shift.

Based on the above discussion, the optimal optical parameters to detect dielectric particles with bound non-dielectric nanoparticles are the Real part and the Imaginary part of the optical field of the particles/aggregates, since the Real part correlate to a large extent with the extinction cross section and thus with the volume of bound non-dielectric nanoparticles, and the Imaginary part correlate to the largest extent with the volume of the dielectric particle. The invention is however not limited to this case, as the imaginary part can be replaced with the induced phase shift of the particle or even with its hydrodynamic size to categorize and differentiate different particle types. Likewise, the Real part may be replaced by the scattering amplitude of the particle as these two are highly correlated for small particles and transmitted light imaging.

When for example, the present invention is used to selectively detect a certain type of virus, there is a risk of false detections in the form of virus debris to which the non-dielectric particles may bind. In such cases it is advantageous to use a third independent parameter to confirm that e.g. an intact virus particle of expected size has been detected. By tracking the particles and determine their diffusion and thus their hydrodynamic size, such an independent confirmation parameter is achieved. In an ideal embodiment of the present invention, dielectric particles labelled with non-dielectric nanoparticles are thus identified within a 3-dimensional parameter space made out of the real part and the imaginary part of the optical field of the particle and the hydrodynamic size of the particle.

As is apparent from the above description, the invention can be used to detect a specific dielectric particle type, e.g. a specific type of virus, in a heterogeneous dispersion by binding non-dielectric nanoparticles to specific receptors. A further possibility is to use two or more different types of non-dielectric nanoparticles having absorption maximum at different wavelengths and functionalized to be capable of binding to different binding receptors and illuminate the sample with light of two different wavelengths to detect the two or more different types of binding.

An advantage of the present invention is that the mass of the dielectric particle can be determined relatively independently of the bound non-dielectric nanoparticles. This is because the bound nanoparticles make out a small part of the mass of the aggregate and a have a very small effect on the imaginary part of the optical field relative to the dielectric particle. This is illustrated in FIG. 3D, where it is shown that a dielectric particle 303 will achieve a drastically increased Real part 301 when one or more non-dielectric nanoparticles 305 are bound to the dielectric particle 303 such that a mixed aggregate 304 is formed, whereas the Imaginary part 302 of the mixed aggregate 304 remains approximately unaffected. Furthermore, this is illustrated in FIG. 9, where it is shown that the Real part increases with increasing addition of gold nanoparticles whereas the Imaginary part remains comparably unaffected. See further Example 1, below. Furthermore, as discussed above, the imaginary part is proportional to VΔn and if Δn and the density of the particle is known, its mass can be determined. For the special case of biological particles, Δn is proportional to the mass concentration of biological molecules within the particles and VΔn is therefore proportional to the dry mass of the particle. The mass of individual virus particles and other small biological particles can thus be determined within the present invention. It shall be noted that if the non-dielectric particles 305 were present as individual, free particles having same size and shape, they should all have the same optical field and thus the same value of the Real part 301 and the imaginary part 302. The same applies for the dielectric particles 303. The differences in the detected optical field, and thus the Real part 301 and Imaginary part 302, of the non-dielectric particles 305 and dielectric particles 303 originates from clustering of the particles to form aggregates with each other, having somewhat different shapes and sizes and the accuracy of the measurements performed. Concerning the mixed aggregates 304 formed, there may be additional differences in the optical field depending on the number of non-dielectric particles 305 which binds to a dielectric particle 303 when forming a mixed aggregate 304. The detected values may also originate from impurities in the sample to be analysed.

Another advantage of the present invention is that the refractive index of the dielectric particles can similarly be determined relatively independently of the bound non-dielectric particles. One conventional method is to use the optical phase shift combined with the hydrodynamic size of the particle to determine the refractive index, since the phase shift is proportional to VΔn. If instead using the imaginary part in place of the phase shift, the effect of the bound non-dielectric nanoparticles is minimized. The bound nanoparticles will affect also the hydrodynamic diameter, it may therefore be advantageous to use not the hydrodynamic diameter of the dielectric/non-dielectric particle aggregates, but the hydrodynamic diameter of the dielectric particles prior to binding, or to make an estimation of how much the non-dielectric nanoparticles contribute to the hydrodynamic diameter. It is thus also advantageous in this case to use non-dielectric particles with a small size relative to the dielectric particles, causing a relatively small increase of the hydrodynamic diameter as depicted in FIG. 9C (further described in Example 1, below).

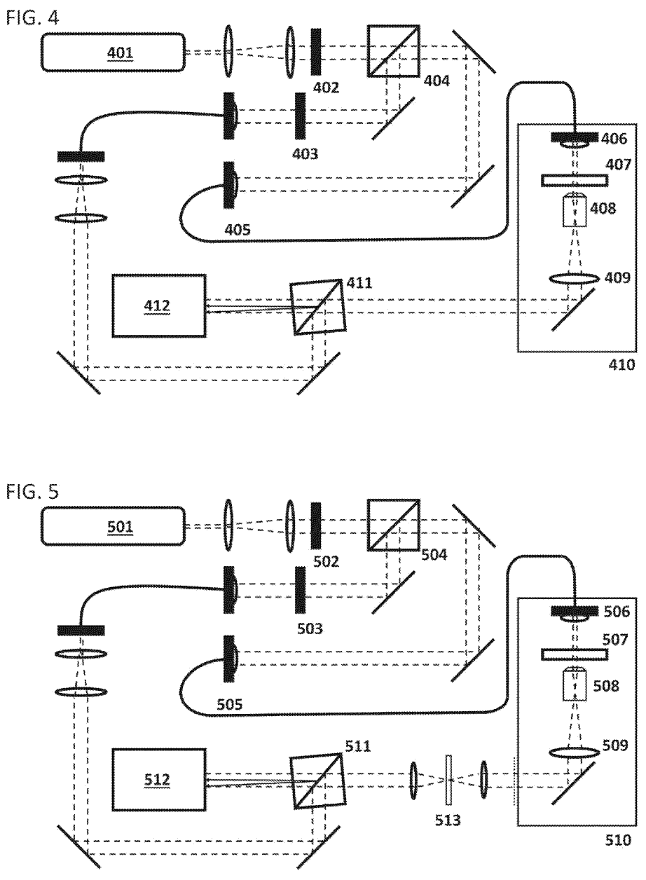

FIG. 4 shows an example of a digital holographic microscope (DHM) set-up suitable for the present invention. The set-up is in this case built around a commercial microscope body of the inverted type, which means that an objective 408 is under the sample. The light beam from a coherent light source 401, such as a laser, is expanded by lenses and directed towards a first beam splitter 404. The first beam splitter 404 is of a polarizing type, which splits the light into two orthogonally polarized beams, a first divided beam which will be directed towards the sample to serve as an object beam and a second divided beam which will by-pass the sample to be used as a reference beam. The laser beam is already partially polarized. By rotating a first half-wave plate 402 between the laser and the first beam splitter 404, the direction of polarization can be adjusted and thereby the relative intensity of the two outgoing beams can be adjusted. A second half-wave plate 403 in the reference beam line adjusts that beam to have the same polarization as the object beam when they meet again at a second beam splitter 411. Hence, a beam splitter is used both as a device for splitting a beam as well as for unifying light beams. The object beam is collected into an optical fibre 405 which connects to a collimator lens 406 comprised in a microscope body 410. The object beam illuminates the sample at a first image plane 407 from above. The liquid sample can for example be placed between a microscope slide and a cover slip, or in a microfluidic channel. The latter option is advantageous in that a controlled liquid flow can be achieved and the thickness of the liquid sample is well defined. After the sample, the beam passes through a microscope objective 408, a tube lens 409, and via a mirror exits the microscope body 410. The object beam is subsequently recombined with the reference beam at the second beam splitter 411. The second beam splitter is slightly rotated compared to the direction of the two beams, which causes the two beams to reach the detector with a slight angle relative to each other, which creates an interference pattern in the image recorded by a camera 412, e.g. a CCD camera.

FIG. 5. shows a DHM set-up according to an embodiment of the invention. The overall set up is similar to the set-up of FIG. 4. FIG. 5 discloses a DHM comprising a coherent light source 501 from which light is guided via first half wave plate 502 to a first beam splitter 504 which divides the light into a first divided beam which will serve as an object beam guided to the sample holder in order to illuminate a sample and a second beam functioning as a reference beam being guided to bypass the sample holder and sample. The reference beam is guided via a second half-wave plate 503 and suitable light guiding means such as mirrors and optical fibres to a second beam splitter 511. The object beam is guided via similar light guiding means including mirrors and an optical fibre 505 to a microscope body 510. In the microscope body, the light is directed to a collimator lens 506 illuminating a sample at the first image plane 507. Downstream of the sample, the beam passes through a microscope objective 508, a tube lens 509, and via a mirror exits the microscope body 510. Hence, these parts correspond to the set-up in FIG. 4. However, the set-up in FIG. 5 further comprises a double lens arrangement including two lenses and a spatial filter 513, e.g. a disk filter obstructing the central portion of the light beam, in the focal plane between the lenses. The light passes through the double lens arrangement and the spatial filter 513 before it enters the second beam splitter 511 to be reunited with the reference beam before being directed to a camera 512. In the microscope body, the objective 508, tube lens 509 and mirror are positioned to create an image plane at the port where the object beam exits the microscope as disclosed in FIG. 4. The 4f-arrangement therefore begins at this plane. Note that FIG. 5. is not drawn to scale and the distance from the first image plane to the first lens is in reality the same as from the second lens to the camera.

It is obvious that the stand-alone double lens arrangement could be replaced with a built-in lens arrangement to be used in the embodiment disclosed in FIG. 5. This arrangement may for example be achieved by placing a disk filter at or in the vicinity of a focal plane between the objective lens 507 and the camera 512 and thus replace the stand-alone arrangement.

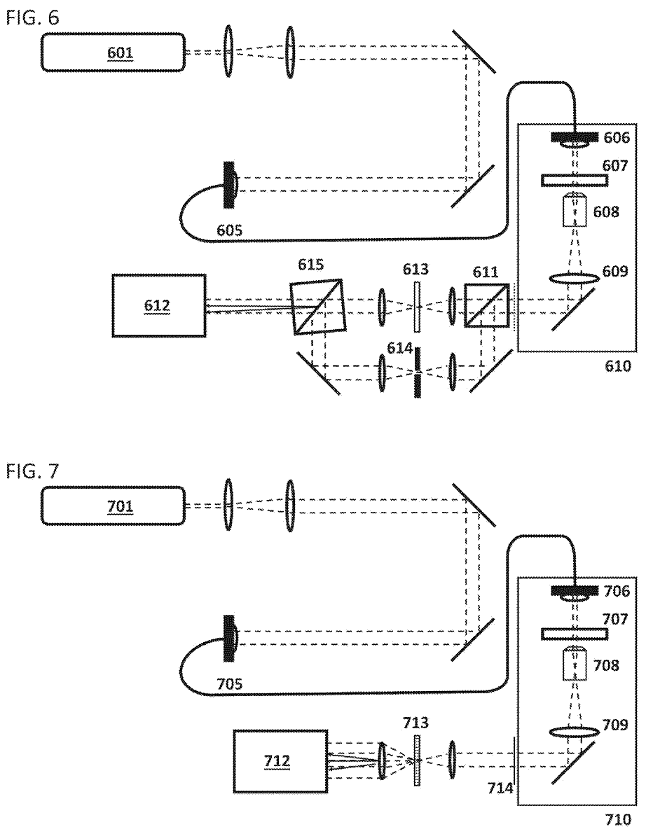

FIG. 6 discloses a DHM setup similar to FIG. 5, but where the first divided beam to be used as the object beam and the second divided beam to be used as reference beam are formed from splitting the base light beam in a first beam splitter 611 located downstream of the sample. The arrangement in FIG. 6 includes an optical fibre 605 for guiding light to a microscope body 610 comprising a collimator lens 606, an objective 608, a tube lens 609 and sample holder arranged for holding a sample to be illuminated in a first image plane 607. However, in this arrangement, the first beam splitter 611 is placed downstream of the objective lens 608 to split up the base light beam in at least a first and a second divided beam to be used as an object beam and a reference beam. To make use of this second divided beam as a reference beam in an off-axis DHM arrangement, it should preferably contain mostly unscattered background light. This is achieved by focusing the reference beam similarly as the object beam. The object beam, i.e. the first divided beam, is guided to a double lens arrangement including a spatial filter 613 in the focal plane between the two lenses in the double lens arrangement in the same way as disclosed in FIG. 5. There is also a double lens arrangement included in the path of the reference beam, i.e. the second divided beam. However, in this case there is a pinhole or transparent area 614 at the centre of the focal plane instead of using an obstructive filter at the center as for the first divided beam functioning as an object beam. Hence, the focused background light can pass in the second divided beam while scattered light is obstructed by the otherwise opaque plate preventing light from passing through such that the second divided beam may be used as a reference beam when the light is recorded by a camera 612. Note that unlike in the figure, the two beam paths will need to be of similar length to enable good interference, unless the laser light has very long coherence length.

FIG. 7 discloses another DHM setup where all light shares a common path. Also this arrangement in FIG. 7 includes an optical fibre 705 for guiding light to a microscope body 710 comprising a collimator lens 706, an objective 708, a tube lens 709 and a sample holder arranged for holding a sample to be illuminated in a first image plane 707 and a double lens arrangement including two lenses and a spatial filter obstructing the central portion of the light beam in the focal plane 713 between the lenses. At the focal plane 713 between the lenses, where the filter is located, also a diffraction grating is placed which separates the light into different diffraction orders. Preferably three orders (−1,0,1) are used. As the orders interfere with each other they give rise to three separate images to be recorded by a camera 712, phase shifted relative to each other and containing holographic information. The spatial filter may be placed on the grating or on a separate substrate. Preferably a mask 714 is placed at the image plane upstream the focal plane, comprising one or several apertures. The aperture or apertures need to transmit light from both an area where the sample is located and an area where the sample is not located which acts as a reference. Alternatively, it is also possible to use a separate reference beam as reference in combination with this type of grating-based method.

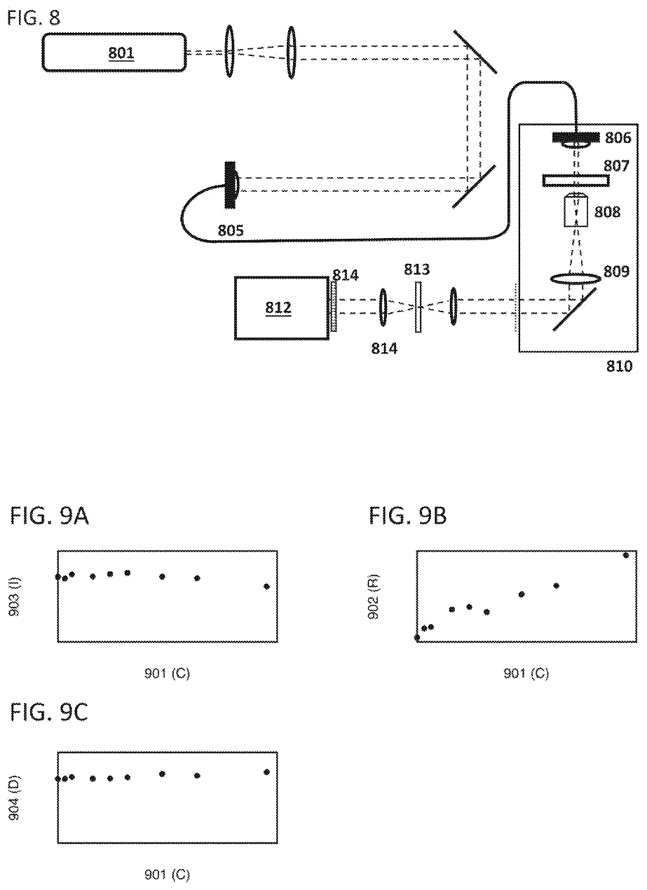

FIG. 8 discloses a DHM setup similar to FIG. 7 where all light shares a common path and includes an optical fibre 805 for guiding light to a microscope body 810 comprising a collimator lens 806, an objective 808, a tube lens 809 and a sample holder arranged for holding a sample to be illuminated in a first image plane 807 as well as a double lens arrangement including two lenses and a spatial filter obstructing the central portion of the light beam in the focal plane 813 between the lenses. The filter is placed in the focal plane 813 between the two lenses as in FIGS. 5 to 7. A grating is placed in close proximity to the camera 812 which is used as detector. The grating may comprise a 2D pattern where different fields provide a different phase shift of the light, these fields may be separated by opaque lines. Light portions having passed different fields interfere with each other at the detector, generating an interference pattern based on four different diffraction orders.

The method described above may be suitably used for detection of a wide variety of biological particles such as viruses, exosomes or micro-vesicles, lipoproteins or particles derived from biological sources. It may also be particles which are synthetically manufactured and resemble particles with a biological origin such as synthetically manufactured virus-like particle. The particles could for example be used for drug delivery, vaccine delivery or gene therapy, or be detected in clinical samples for diagnostic purposes.

The label non-dielectric particles may be functionalized with an antibody to bind to a specific species of virus or a specific group of viruses. The non-dielectric particles could also be functionalized with other functional groups or molecules such as aptamers, dendrimers or specific organic or inorganic substance. The label non-dielectric particles could also be functionalized to non-specifically bind to any enveloped virus. Several of these features are demonstrated in the following examples.

### Example 1

In a first example, using an off-axis holographic microscope according to FIG. 5 with a 40× 1.3NA oil objective (Olympus) and 532 nm DPSS laser (Roithner) was used to detect 300 nm diameter silica particles. A spatial filter consisting of a gold-disc of 55 nm in thickness and 0.5 mm in diameter was placed in the focal plane between two lenses, although the silica particles were detectable also without this filter. The samples were imaged under flow in a microfluidic chip with channels of 20×800 micron cross-section from the manufacturer Chipshop. Details of the physical setup and image processing have been described in Midtvedt et al, Analytical Chemistry, 2020 & Midtvedt et al, ACS Nano 2021.

Silica particle dispersion having a diameter of 300 nm was mixed with gold nanoparticle dispersion having a diameter of 10 nm diameter) in different proportions. Subsequently a fixed amount of salt solution was added to induce aggregation, after 10 seconds the resulting solution was diluted with pure MilliQ water to slow the aggregation before injecting the solution into the microfluidic chip. In a solution containing only silica particles as dielectric particles, the detected dielectric particles 303 were found to have a low value on the Real axis 301 and a high value on the Imaginary axis 302 as in FIG. 3A. Individual 10 nm gold nanoparticles could not be detected, but aggregates of gold nanoparticles 305 caused by addition of salt could be detected and had a high negative real part and a low imaginary part. When gold particles and silica particles were mixed and caused to aggregate by salt addition to form mixed aggregate particles (102, see FIG. 1) of dielectric silica particles labelled with non-dielectric gold particles, the optical field, represented as a complex number, of detected particles were shifted to the left along the Real axis 301 in a complex coordinate system as disclosed in FIG. 3A-C. The higher the ratio of gold nanoparticles to silica particles, the more the mixed aggregate particles 102 of dielectric silica particles labelled with non-dielectric gold particles were shifted to the left along the Real axis 301 in the complex plane as more gold particles were attached to the silica particles. Particles with an imaginary part<0.4×10⁴ nm² were subsequently excluded from the data so that the very most of the remaining particle detections were mixed aggregate particles comprising single silica particles with attached gold nanoparticles, whereas aggregates of gold nanoparticles where excluded. The remaining particles were then separately analysed, with the following results: FIG. 9A. shows a plot of the imaginary part 903 (integrated over the particles projection) against gold/silica ratio 901. This plot shows that the imaginary part is approximately independent of the gold concentration. FIG. 9B shows a plot of the real part 902 against gold/silica ratio 901, demonstrating a monotonous and approximately linear relationship between the two. For the highest gold/silica ratio the shift in real part corresponded to 500 gold nanoparticles which is considered a realistic number given that this would correspond to a surface coverage of 14% and the initial number concentration ratio was 3000:1 gold:silica. FIG. 9C. show the hydrodynamic radius 904 derived from the Brownian motion of the detected particles against added gold concentration. The radius shows a small increase at high gold/silica ratios due to the attached gold nanoparticles, which would be expected if gold aggregates rather than individual gold nanoparticles attach to the surface. This example demonstrates the concept of the invention by detecting dielectric silica particles and showing a “dose-response” effect of added non-dielectric gold nanoparticles on the real part of the optical field of the nanoparticle labelled dielectric particles.

### Example 2

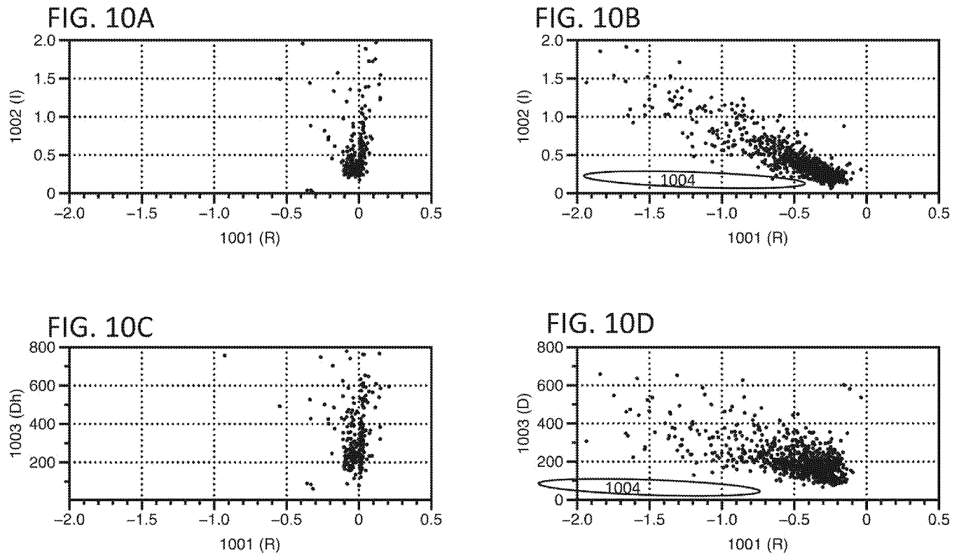

In a second example, using the same experimental setup as in Example 1, Herpes simplex virus type 2 (HSV-2) was labelled with gold nanoparticles of 10 nm diameter. The gold nanoparticles were surface modified with tannic acid, causing them to bind to the outer membrane of viruses in general. With reference to FIGS. 10, 10A and 10C shows plots of detected particles in pure HSV-2 dispersion and 10B and 10D shows plots of detected particles in HSV-2 dispersion with modified gold nanoparticles added. The concentration of HSV-2 was the same in both dispersions. The upper plots (A,B) show the complex optical field of the particles (Imaginary (1002) vs Real (1001)), whereas the lower plots (C,D) show hydrodynamic diameter (1003) vs the real part of the optical field (1001). When the Tannic Acid modified nanoparticle (TaNP) dispersion alone was analysed, very few particles were observed (data not shown). When the HSV-2 solution was analysed without TaNP addition, some particles were observed, which all mainly had a high imaginary part and low real part and a broad hydrodynamic diameter distribution centred around 240 nm (See FIGS. 10A (Im vs Re) and 10C (Dₕ vs Re). This is significantly larger than the anticipated HSV-2 diameter around 150-200 nm, indicating that most of the detected particles corresponds to virus aggregates, whereas single virus particles were below the detection limit. When the HSV-2 solution was mixed with the TaNPs, the optical signal changed significantly (see FIG. 10B, 10D). The number of detected particles increased by more than one order of magnitude and the detected particles had a lower Im/Re-ratio than previously. The hydrodynamic diameter of the detected TaNP labelled particles were now in the range expected for HSV-2 from literature and only slightly larger than in reference measurements with conventional darkfield nanoparticle tracking analysis (NTA). Unlike in Example 1, no separate population of gold nanoparticle clusters was detected, presumably because Example 1 concerned more unspecific agglomeration, whereas in the present example the gold nanoparticles preferentially bound to virus particles. 1004 marks where in the plots pure TaNP clusters would be expected to appear.

As a reference experiment, HSV-2 dispersion was mixed with gold nanoparticles functionalized with PEG (Polyethylene glycol) instead of tannic acid, which is expected to hinder binding instead of promoting it. This resulted, as expected, in a much smaller shift in optical signal (data not shown).

Taken together, these results show that most of the virus particles in the HSV-2 sample could not be detected with the specific experimental setup and imaging parameters, but could be made detectable and characterizable by binding TaNPs to them. Thus, we are here able to selectively analyse only components that bind to the TaNPs, demonstrating the possibility to quantify specific subpopulations of a heterogeneous sample.

### Example 3

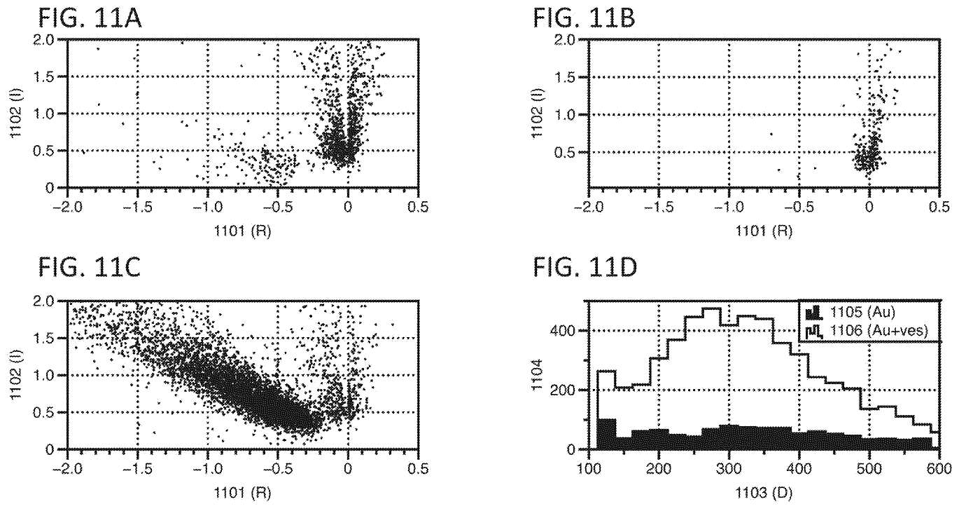

In a third example, using the same experimental set-up as in example 1 and 2, more specific binding was demonstrated, using streptavidin and biotin functionalization. As dielectric particles, liposomes/vesicles were synthetically manufactured from 95% POPC and 5% Biotinyl cap DOPE. The vesicles had a median diameter of 200 nm, as measured on an NTA instrument (Nanosight). Spherical gold nanoparticles with a diameter of 22 nm were functionalized with PEG as well as biotinylated PEG. The ratio of biotinynilated PEG to gold nanoparticles was selected such that one biotin group per particle was expected on average. Subsequently, strepativin was added to bind to the biotin on the gold particles, and which could subsequently function as a binding site for the biotin groups of the vesicles. PEG is generally hindering interaction between particles, by combining PEG functionalization with biotin functionalization, non-specific binding is minimized. Each sample was analyzed from 2 min of recording of sample under flow. FIG. 11A shows the complex optical field of only the functionalized gold nanoparticles, diluted to 3.6×10¹¹ particles/ml. A small population of gold nanoparticle clusters can be seen close to the Real axis 1101. A rather large population of dielectric particles can also be seen close to the imaginary axis, presumably due to aggregation of the synthesis components and/or pollution of the sample. FIG. 11B shows the optical field of a sample of only vesicles, with a concentration of 1.6× ×10⁹ particles/ml. Here only a relatively small dielectric particle population is detected. FIG. 11C shows the complex optical field of a mixture of the two solutions with the same concentration of the respective particles as in the individual measurements. Here a large particle population with an intermediate Im/Re ratio can be seen in addition to the dielectric impurity population close to the Im axis. The detected particle concentration is much higher in this sample, see histogram in FIG. 11D. Here the number of detected particles 1104 is plotted against hydrodynamic diameter 1103. A histogram of vesicles mixed with gold particles 1106 is contrasted against gold particles only 1105. The population of dielectric impurities in the gold nanoparticle sol can be seen to decrease when mixed with the vesicles, presumably since the impurities comprise some streptavidin which binds to the vesicles. This highlights the importance of avoiding contamination of the label nanoparticles.

1-14. (canceled)

15. A method for detecting dielectric particles of submicrometer size wherein
a) a sample is prepared by mixing dielectric particles of submicrometer size with non-dielectric nanoparticles whereby non-dielectric nanoparticles and dielectric particles of submicrometer size bind to each other to form nanoparticle-labelled dielectric particles to be detected;
b) The particles in the sample are optically detected and at least one parameter in each of the following parameter groups i. and ii. are determined
i. the real part of the optical field of the particles or optical extinction
ii. imaginary part of optical field of the particles or phase shift, alternatively or in addition diffusivity-derived hydrodynamic diameter;
said method further comprising the feature that detected nanoparticle-labelled dielectric particles and populations of particles are identified and differentiated from other detected particles and populations of particles, such as free or clusters of non-dielectric nanoparticles and unlabelled dielectric particles, by identifying particles as nanoparticle-labelled dielectric particles when they have a higher ratio of parameter from parameter group i. to parameter from parameter group ii. than expected for dielectrical particles and having a lower such ratio than expected for individual non-dielectric nanoparticles or clusters thereof.

16. A method for detecting dielectric particles of submicrometer size according to claim 15, wherein at least one parameter from each one of parameter groups i. and ii. in step b are used to categorize detected particles into particle populations with different population density maxima in the parameter space of the said at least two parameters.

17. A method for detecting dielectric particles of submicrometer size according to claim 15, wherein the parameter or parameters to be detected from parameter group ii. comprises the imaginary part of the optical field or phase shift.

18. A method for detecting dielectric particles of submicrometer size according to claim 15, wherein the imaginary part of the optical field is used as a parameter in parameter group ii.

19. A method for detecting dielectric particles of submicrometer size according to claim 15, wherein the real part of the optical field is used as a parameter in parameter group i.

20. A method for detecting dielectric particles of submicrometer size according to claim 15, wherein the imaginary part of the optical field is used as a parameter in parameter group ii and that the real part of the optical field is used as a parameter in parameter group i.

21. A method for detecting dielectric particles of submicrometer size according to claim 20, wherein the diffusion-based hydrodynamic size is used as an independent parameter relative to the other two to categorize the particles.

22. A method for detecting dielectric particles of submicrometer size according to claim 15, wherein the mass of nanoparticle-labelled dielectric particles, less the label nanoparticles, is estimated and where the mass of the dielectric particle is derived from the Imaginary part of the optical field of the nanoparticle-labelled dielectric particles.

23. A method for detecting dielectric particles of submicrometer size according to claim 15, wherein the refractive index of nanoparticle-labelled dielectric particles, less the label nanoparticles, is estimated and where the refractive index of the dielectric particle is derived from the Imaginary part of the optical field of the nanoparticle-labelled dielectric particles in combination with the estimated hydrodynamic radius of the dielectric particle.

24. A method for detecting dielectric particles of submicrometer size according to claim 15, wherein the particles are detected and characterized by holographic microscopy, said method including the use of a digital holographic microscope, DHM, comprising
A coherent light source for creating a base light beam for illuminating a sample in a first image plane,
A sample holder for holding a sample to be illuminated,
A detector, e.g. a camera, arranged to record images of light transmitted through a sample in the sample holder,
A first beam splitter for dividing the base light beam from the coherent light source into at least a first divided beam and a second divided beam, and
A light beam guiding system for guiding said base light beam or said first divided light beam through the sample and further arranged to guide said first and second divided beam to reunite at a reuniting point before the first and second beams are directed to the detector.

25. The method for detecting dielectric particles of submicrometer size according to claim 24, wherein background light unscattered by the sample in the first divided beam is dampened relative to the light in the same beam, scattered by the sample, by a filter.

26. A method for detecting dielectric particles of submicrometer size according to claim 15 wherein the sample is imaged under flow, the method further comprising:
determining the flow rate based on particle tracking data; determining liquid volume passing the imaged volume during a period of time; and
counting the detected virus or biological particles during the same period of time, in order to determine the number concentration of virus or biological particles.

27. A digital holographic microscope, DHM, for detecting dielectric particles of submicrometer size, the digital holographic microscope comprising
a coherent light source for creating a base light beam for illuminating a sample,
a sample holder located in a first image plane for holding a sample to be illuminated,
a detector such as a camera arranged to record images of light transmitted through a sample in the sample holder,
a light beam guiding system for guiding the base light beam through the sample and to the detector—a means for dividing the base light beam into different portions, said portions each comprising light not scattered by the sample, and causing the different portions of the light beam to interfere with each other at the detector, and
a filter adapted to dampen the portions of the base light beam unscattered by a sample by at least 50%, preferably by at least 90%, or by 99%, in order to reduce background light.

28. The digital holographic microscope according to claim 27, wherein the means for dividing the base light beam into different portions comprises at least one of a cube beam splitter, plate beam splitter, fiber splitter, lattice, grating or grid configured to induce a shift in the direction of light.

29. The digital holographic microscope according to claim 27, where the non-dielectric nanoparticles are plasmonic nanoparticles e.g. particles comprising gold, silver, palladium or platinum.
